(19) United States
(12) Patent Application Publication
(10) Pub. No.: US 2007/0228814 A1
(43) Pub. Date: Oct. 4, 2007

(54) Trailer brake steering system

(75) Inventor: Steven Lee Miller, Payson, AZ (US)

Correspondence Address: Steven L Miller, 708 N Mazatzal Cir., Payson, AZ, 85541, US

(73) Assignee: Mr. Steven Lee Miller, Payson, AZ (US)

(21) Appl. No.: 11/731,358

(22) Filed: Mar. 30, 2007

Related U.S. Application Data
(60) Provisional application No. 60/788,017, filed on Mar. 31, 2006.

(51) Int. Cl. B60T 13/00

(52) U.S. Cl. 303/7; 303/9.66; 303/123

(57) ABSTRACT

A trailer brake steering system for towed vehicles is disclosed which provides for independent controlled application of said brakes in order to help give directional control of towed vehicle. The system is designed with many preferred embodiments. Which allows the system to be used on different towed vehicle braking systems including but not limited to Electric, Hydraulic, and Pneumatic. In each case, superior performance is obtained because the system operates the brake system of the towed vehicle in a unique manner.

### RELATED APPLICATIONS

The present application is a continuation-in-part application of U.S. provisional patent application, Ser. No. 60/788,017, filed Mar. 31, 2006, for TRAILER BRAKE STEERING SYSTEM, by Steven L Miller, included by reference herein and for which benefit of the priority date is hereby claimed.

### FIELD OF THE INVENTION

The present invention relates to trailers and, more particularly, to the manipulation of the brake system, to facilitate directional control of said trailer.

### BACKGROUND OF THE INVENTION

Ever since man has been able to tow a trailer of one form or another. (Utility, Recreational Vehicle, Horse, Stock, Boat etc.) They have had one decisive problem. The reliance on the tow vehicle to control the direction of the trailer. While moving in a forward direction this does not pose a substantial problem. The majority of people incur problems when it comes to the backing of the trailer.

In backing a trailer the only current, directional control comes from the tow vehicle. This is accomplished by turning the connecting end of the tow vehicle in order to make the trailer pivot, or turn. There are several problems that arise with this form of directional control of the trailer:

1: The driver of the tow vehicle often gets confused on which way to turn the steering wheel of the tow vehicle (clock wise, or counter clock wise) in order to get the trailer to turn in the desired direction.

2: The length, or wheel base and the turning radius of the towing vehicle will greatly effect the turning area needed for the front of the tow vehicle to rotate or “swing” in order to get the trailer to turn. This will correspondingly increase the needed time, and distance traveled to make the trailer react and start to turn.

3: The length, or wheel base (distance from the trailers tong to the trailer's wheels) of the trailer will greatly effect the needed time and distance traveled to make the trailer react and start to turn.

4: The surface of which the trailer is on will greatly effect how responsive the trailer will be to turning. On lose surfaces such as dirt, or gravel the trailer will not want to respond, and turn vary slow. On hard surfaces such as pavement, or concrete the trailer will want to respond vary fast, even to the point of turning the trailer past the point you had intended.

5: The problems in afore mentioned #4 can increase the turning area needed by the tow vehicle, and the time and distance traveled by the trailer in order for it to respond and start to turn. And in most cases will end in the driver of the tow vehicle having to stop and pull forward to straighten the trailer several times in order to achieve the desired result.

6: In most cases the areas in which one will have to perform backing of the trailer, turning space will be at a premium which will increase afore mentioned problems # 2, 3, 4, 5.

7: In some cases once you have successfully turned the trailer into an opening such as a gate, other obstructions can block the tow vehicle from being able to straighten out and fallow the trailer threw said gate or opening.

8: In other cases when a trailer is successfully turned into an opening or gate, and the driver straighten out the tow vehicle, the driver can only keep the trailer turning in the same direction as before or straight, but can not immediately turn the trailer in the opposite direction. This would entail stopping and moving tow vehicle forward, and start to “swing” or turn tow vehicle in opposite direction. If distance and area are available. In most cases the area in limited.

9: The driver of tow vehicle can not see exactly where trailer is going, or any obstructions trailer might hit. Even with use of mirrors the driver loses's sight of the trailer because of the angle needed by tow vehicle in order to achieve turning of the trailer. The length and size of trailer will increase this problem. In some cases ware a second person is available to help direct the driver of the tow vehicle “spotter” some advantage is gained. But this is a small advantage do to pore communication between driver and spotter, and the time it take for the driver to react and start the process of turning the trailer.

It is therefore an object of the invention to enable a auxiliary,or alternate means of directional control of the trailer while backing up.

It is another object of the invention to enable the directional control of the trailer during backing up, while keeping the tow vehicle straight.

It is another object of the invention to enable a person other than the operator of the tow vehicle, to control the direction of the trailer “spotter”.

It is another object of the invention to make backing of a trailer less confusing.

It is another object of the invention to make the effect of the length or wheel base of the tow vehicle, and trailer less of a factor, on the control of a trailer while backing.

It is another object of the invention to help in controlling, and correcting a trailer's direction while on different surface conditions. “gravel, dirt, pavement, concrete etc.”It is another object of the invention to make steering of trailer easier in areas that have reduced, or restricted the turning capabilities of tow vehicle.

It is another object of the invention to make steering of trailer easier in areas of reduced quarters.

It is another object of the invention to provide a directional control system that may be easily retrofit on a variety of vehicles that are typically towed behind another vehicle.

It is another object to the invention to have the ability to offer simple conversions of the main embodiment “electric brakes” to subembodiments “hydraulic, and pneumatic brakes”.

### SUMMARY OF THE INVENTION

In accordance with the present invention, there is provided a transmitter with at lest two control functions. The transmitter sends commands to the receiver. The receiver sends a electrical current to a right or left relay or suitable electronic device which will cut the power from the electric brake master controller and replaces it with its own electrical current. This cutting off of the master brake controller and replacing of electrical current will allow the operator to use the brakes independently of each other and at varying resistance. This will enable the operator to steer the trailer while backing up, with out having to rely on the tow vehicle for the soul means of steering control.

The receiver gains it power from a electric wire running up to the wire harness, and on to another relay or suitable electronic device. The relay or suitable electronic device is connected to the back up, or reverse light's positive electric supply wire on the towing vehicle. This enables the “trailer brake steering system” to only be active when tow vehicle is in reverse.

The “trailer brake steering system” can have many embodiments which will enable the control of trailers with electric, pneumatic, or hydraulic brakes.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a schematic of embodiment #1 view of a wiring diagram related to a trailer with electric brakes;

FIG. 2 is a schematic view of a relay;

FIG. 3 is a schematic of embodiment #2 view of a diagram of wiring, and hydraulic lines related to trailer with hydraulic brakes;

FIG. 4 is a schematic of embodiment #3 view of a diagram of wiring, and pneumatic lines related to a trailer with pneumatic brakes; and

FIG. 5 is a front partial view of a transmitter.

For purposes of clarity and brevity, like elements and components will bear the same designations and numbering throughout the Figures.

### DESCRIPTION OF THE PREFERRED EMBODIMENT

The following detailed description illustrates the invention by way of example and not by way of limitation. this description will clearly enable one skilled in the art to make and use the invention. It describes several embodiments, adaptations, variations, alternatives and uses of the invention, including what we presently believe is the best mode of carrying out the invention. As various changes could be made in these constructions without departing from the scope of the invention, it is intended that all matter contained in the description or shown in the accompanying drawings shall be interpreted as illustrative and not in a limiting sense.

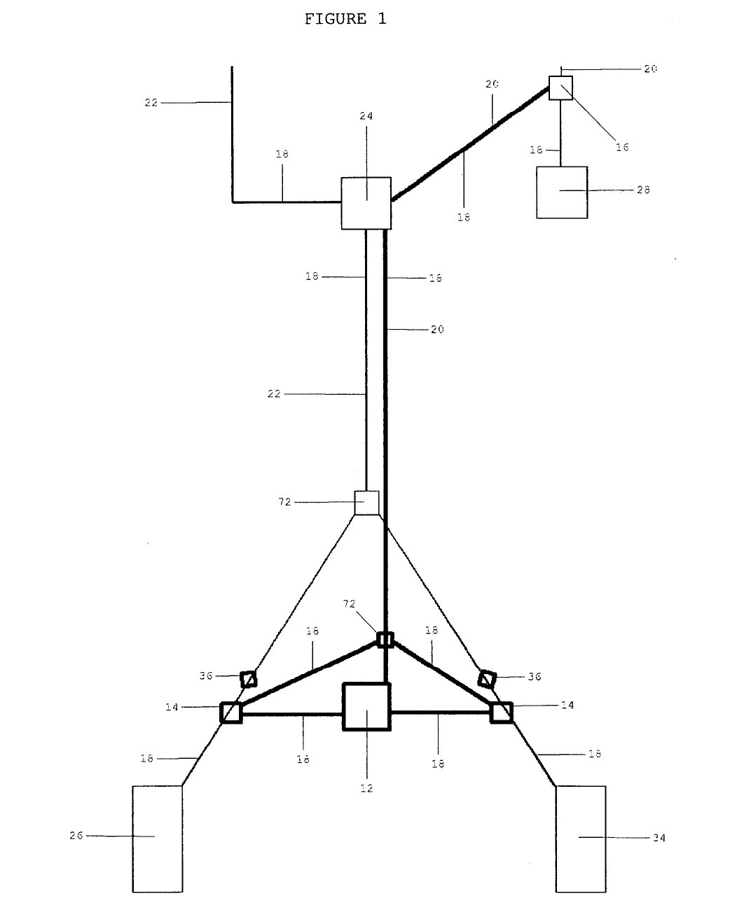

FIG. 1 is a schematic view of one illustrative embodiment of the “Trailer brake steering system”, which relates to trailers with electric brakes.

On the top of this view left side you can see the incoming voltage/current from electric brake controller 22. It runs to the connection harness 24 that is mounted to the back of the tow vehicle. The voltage/current runs through the wiring to a wire splitter 72 that separates the voltage/current to the electric brake “driver's side” 26 and electric brake “passenger side” 34. This is the normal setup on a trailer with electric brakes.

The power to run the “Trailer brake steering system” comes from the backup or reverse light 28 on the tow vehicle. This is accessed buy use of a wirer connecter 16 connected to the incoming voltage/current from backup light 20 wire. The incoming voltage/current from backup light 20 was chosen specifically to supply power for the reason that the power will only be active while tow vehicle is in reverse. As soon as vehicle is taken out of reverse the power supply is off and the “Trailer brake steering system” goes dead. Although it can be connected to any suitable power source.

The following parts will be connected with electrical wiring 18. A wirer connecter 16 that is connected to the incoming voltage/current from backup light 20 is then connected to the connection harness 24, so as to be able to connect and be unconnected with other wiring on the trailer. The electrical wiring 18 caring the incoming voltage/current from backup light 20 makes it way to a wire splitter 72 and a electric powered receiver with varying current output 12. From the wire splitter 72 the incoming voltage/current is sent to a relay or suitable electronic device, which has plurality 14 that is on the driver and passenger side of the trailer. When the relay is activated, it will cut the incoming voltage/current from electric brake controller 22. The electric powered receiver with varying current output 12 is controlled from a transmitter 10 which can be wireless “which is preferred embodiment” but can also be hard wired. The transmitter 10 will tell the receiver to send power to the relay or suitable electronic device, which has plurality 14 that is on the driver or passenger side of the trailer. The controlled voltage/current from the electric powered receiver with varying current output 12 connects to the incoming voltage/ current from electric brake controller 22. When this happens, it sends voltage/current to the trailer brake on the driver's or passenger side of the trailer. There will be placed a diode or suitable device, which has plurality 36 on the incoming voltage/current from electric brake controller 22 line. Both driver and passenger side of the trailer, inline and just above the relay or suitable electronic device, which has plurality 14. This will keep the voltage/current from the electric powered receiver with varying current output 12 from back tracking in the incoming voltage/current from electric brake controller 22 line. Now the voltage/current from the electric powered receiver with varying current output 12 will control the electric brake “driver's side” 26 and electric brake “passenger side” 34 independently with varying amounts of resistance.

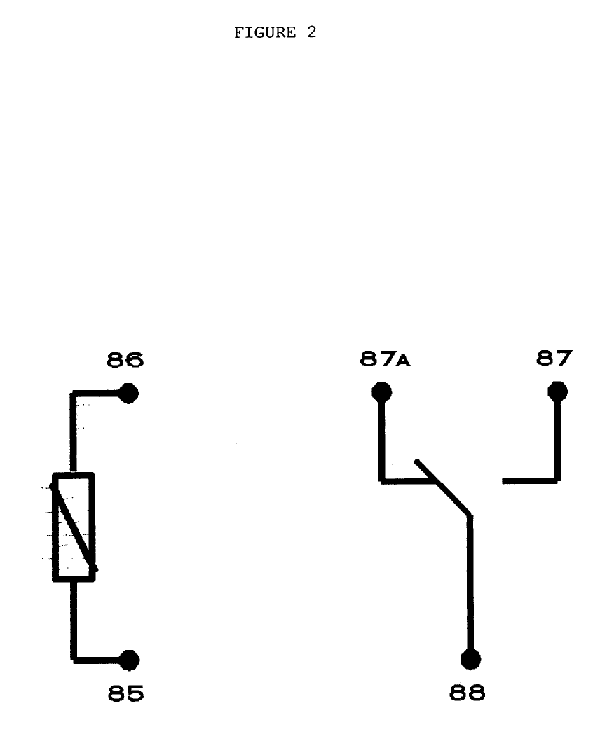

FIG. 2 is a schematic view of the relay or suitable electronic device, which has plurality 14. There will be one on the driver side and passenger side of the trailer.

Number 86 is connected to ground. Number 85 is connected to the incoming voltage/current from backup light 20. Number 88 and 87A are spliced in between the incoming voltage/current from electric brake controller 22 wire. There will be a wire splitter 72 on the number 87A to allow it to be connected to the incoming voltage/current from electric brake controller 22, and the electric powered receiver with varying current output 12 exiting wire. Number 87 will be left empty.

When the incoming voltage/current from backup light 20 goes “hot” it will cause 85 to trigger the relay or suitable electronic device, which has plurality 14. When this happens 88 will flip from 87A to 87. This will disconnect the incoming voltage/current from electric brake controller 22 from the electric brakes on both sides of the trailer. Now the electric powered receiver with varying current output 12 is free to control the electric brakes through the connection at 87A.

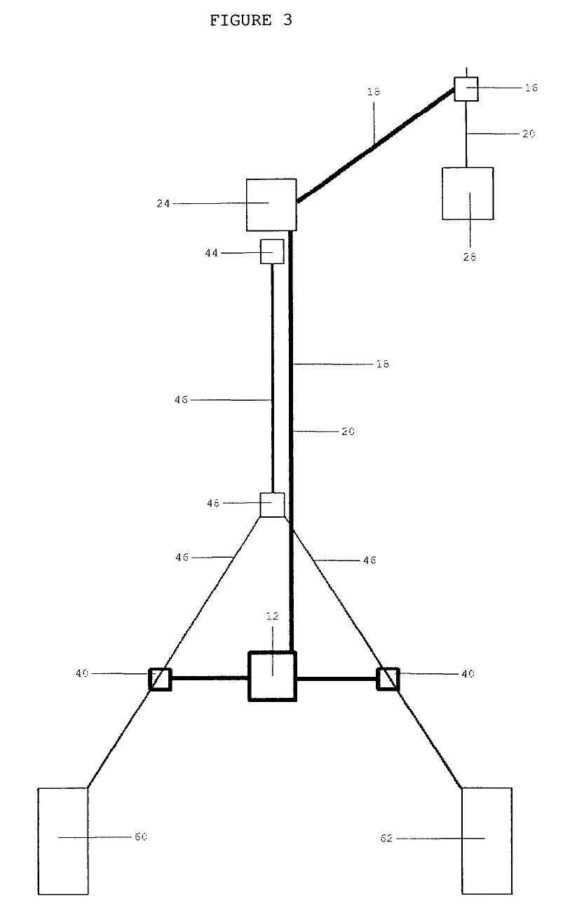

FIG. 3 is a schematic of one illustrative embodiment of the “Trailer brake steering system”, which relates to trailers with hydraulic brakes.

Starting at the front of the trailer is a master cylinder 44. This has a piston in it that supplies the pressure to the brake lines when the tow vehicle slows down. The master cylinder 44 is connected to a hydraulic line splitter 48 with a hydraulic line 46. The hydraulic line splitter 48 separates the main hydraulic line 46 into two separate hydraulic line 46 leading to a hydraulic brake “driver's side” 60 and a hydraulic brake “passenger side” 62.

At the top right side of FIG. 3 is a incoming voltage/current from backup light 20 leading to a backup or reverse light 28. These are connected by electrical wiring 18. There is a wirer connecter 16 connected to the incoming voltage/current from backup light 20 to supply the power to the rest of the electrical components. The incoming voltage/ current from backup light 20 is carried on the electrical wiring 18 to a connection harness 24, and on to a electric powered receiver with varying current output 12. The electric powered receiver with varying current output 12 is then connected to a hydrostatic pump or suitable device, which has plurality 40 on the driver or passenger side of the trailer with electrical wiring 18. The hydrostatic pump or suitable device, which has plurality 40 is spliced into the hydraulic line 46 on the driver's and passenger side of the trailer.

When the tow vehicle is put into reverse this sends the incoming voltage/current from backup light 20 to the electric powered receiver with varying current output 12 activating it. Now the electric powered receiver with varying current output 12 is ready to receive commands from a transmitter 10. The transmitter 10 tells the electric powered receiver with varying current output 12 to send varying amounts of voltage or current to the hydrostatic pumps independently or simultaneously. This will give the driver of the tow vehicle independent control of the hydraulic brake “driver's side” 60 and hydraulic brake “passenger side” 62 which will give directional control of the trailer.

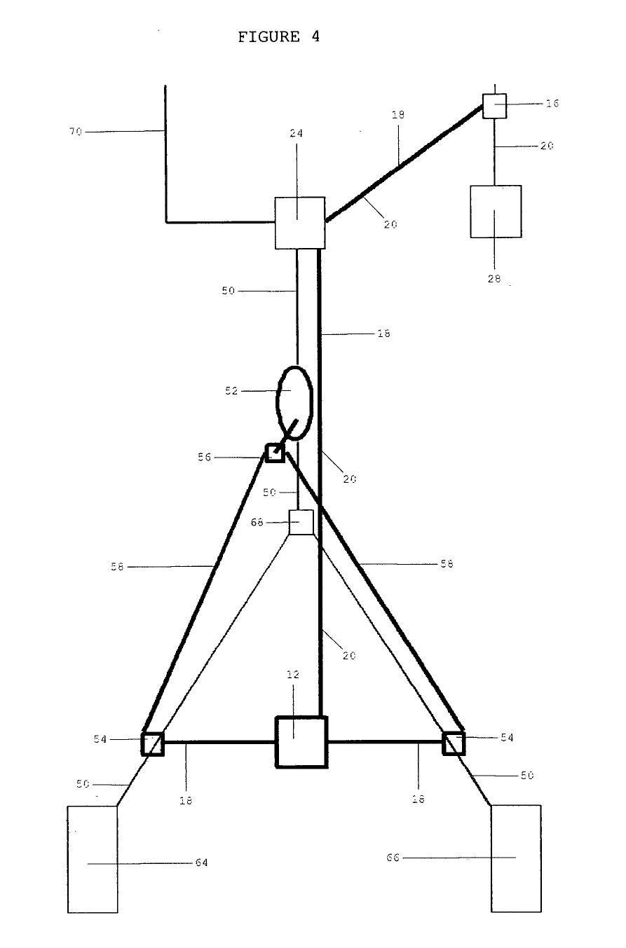

FIG. 4 is a schematic of one illustrative embodiment of the “Trailer brake steering system”, which relates to trailers with pneumatic brakes.

On the top left of FIG. 4 is a pneumatic main line from tow vehicle 70 which leads to a connection harness 24. From the connection harness 24 the pneumatic gas is taken to a pneumatic holding tank 52 through a pneumatic lines 50, and on to a pneumatic line splitter 68. This separates the main line and runs separate lines to a pneumatic brake “driver's side” 64 and pneumatic brake “passenger side” 66. This represents the basic setup on a trailer with pneumatic brakes.

On the top right of FIG. 4 is a incoming voltage/ current from backup light 20 leading to a backup or reverse light 28. These are connected by electrical wiring 18. There is a wirer connecter 16 connected to the incoming voltage/current from backup light 20 to supply the power to the rest of the electrical components. The incoming voltage/ current from backup light 20 is carried on the electrical wiring 18 to a connection harness 24, and on to a electric powered receiver with varying current output 12. The electric powered receiver with varying current output 12 is then connected to a pneumatic bypass valve or suitable device, which has plurality 54 on the driver or passenger side of the trailer. The pneumatic bypass valve or suitable device, which has plurality 54 is spliced into the pneumatic lines 50 on the driver's and passenger side of the trailer. In the middle of FIG. 4 in a pneumatic line connection 56 connected to the pneumatic holding tank 52. From the pneumatic bypass valve or suitable device runs secondary pneumatic lines 58 leading back to the pneumatic bypass valve or suitable device, which has plurality 54.

When the tow vehicle is put into reverse this sends the incoming voltage/current from backup light 20 to the electric powered receiver with varying current output 12 activating it. Now the electric powered receiver with varying current output 12 is ready to receive commands from a transmitter 10. The transmitter 10 tells the electric powered receiver with varying current output 12 to send varying amounts of voltage or current to the pneumatic bypass valve or suitable device, which has plurality 54 independently or simultaneously. This opens the pneumatic bypass valve or suitable device, which has plurality 54 to varying amounts, letting pneumatic gas from the pneumatic holding tank 52 travel through the pneumatic line connection 56, and secondary pneumatic lines 58 to the pneumatic brakes. This will give the driver of the tow vehicle independent control of the pneumatic brake “driver's side” 64 and pneumatic brake “passenger side” 66 which will give directional control of the trailer.

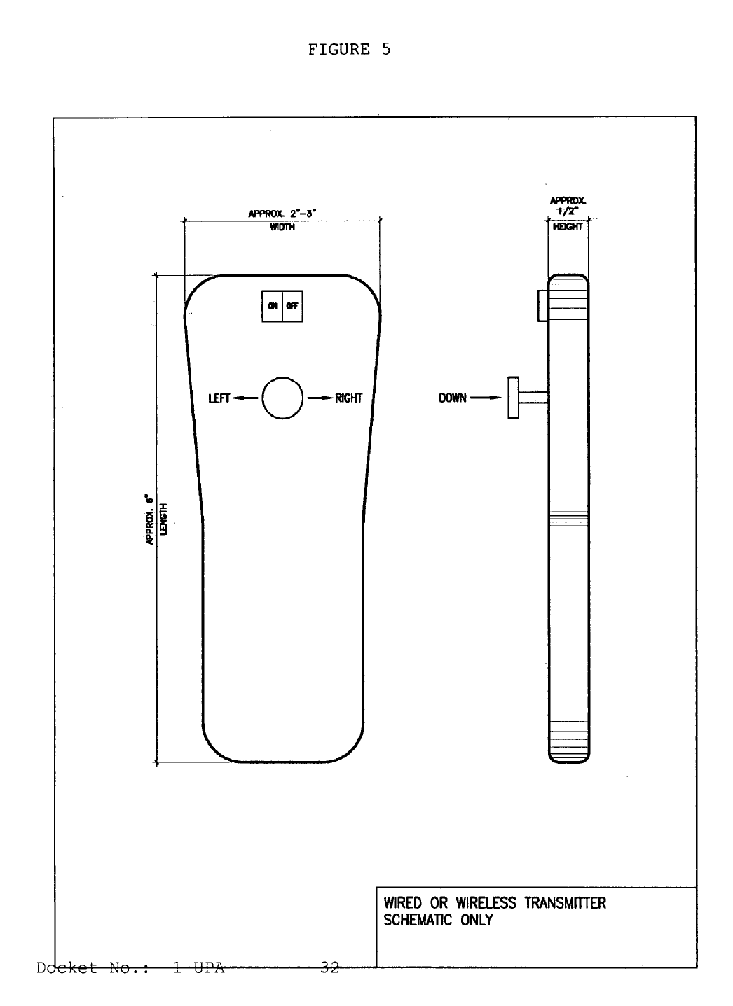

FIG. 5 which is a front partial view of a transmitter 10. This is given by way of example,and not by way of limitation.

On the top of the transmitter 10 “front view” you have a on/off button. Below on the front view you have a thumb control, or joystick. When the thumb control is moved LEFT or RIGHT the transmitter 10 will send a signal to the electric powered receiver with varying current output 12. In turn sending varying amounts of brake pressure to the wheel. If the thumb control is pushed down, as shown in the side view of the transmitter 10. The transmitter 10 will send a signal to the electric powered receiver with varying current output 12 telling it to apply both brakes equally.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A trailer brake steering system for facilitating directional control of said trailer by manipulation of of said brakes, comprising:
means for sending controlling signals to receiver;
means for receiving signals from transmitter, and turning signals into directional voltage with varying current;
means for making the electrical current flow in one direction;
means for stopping, or diverting the flow of electricity;
means for providing single directional pressure to the hydraulic brake line;
means for supplying air pressure to secondary pneumatic lines;
means for supplying air pressure to pneumatic bypass valve; and
means for cutting the main air flow from holding tank and replace with adjustable air pressure from secondary pneumatic lines.

2. The trailer brake steering system in accordance with claim 1, wherein said means for sending controlling signals to receiver comprises a transmitter.

3. The trailer brake steering system in accordance with claim 1, wherein said means for receiving signals from transmitter, and turning signals into directional voltage with varying current comprises an electric powered receiver with varying current output.

4. The trailer brake steering system in accordance with claim 1, wherein said means for making the electrical current flow in one direction comprises a diode or suitable device, which has plurality.

5. The trailer brake steering system in accordance with claim 1, wherein said means for stopping, or diverting the flow of electricity comprises a relay or suitable electronic device, which has plurality.

6. The trailer brake steering system in accordance with claim 1, wherein said means for providing single directional pressure to the hydraulic brake line comprises a hydrostatic pump or suitable device, which has plurality.

7. The trailer brake steering system in accordance with claim 1, wherein said means for supplying air pressure to secondary pneumatic lines comprises a pneumatic line connection.

8. The trailer brake steering system in accordance with claim 1, wherein said means for supplying air pressure to pneumatic bypass valve comprises a secondary pneumatic lines.

9. The trailer brake steering system in accordance with claim 1, wherein said means for cutting the main air flow from holding tank and replace with adjustable air pressure from secondary pneumatic lines comprises a pneumatic bypass valve or suitable device, which has plurality.

10. A trailer brake steering system for facilitating directional control of said trailer by manipulation of of said brakes, comprising:
a transmitter, for sending controlling signals to receiver;
an electric powered receiver with varying current output, for receiving signals from transmitter, and turning signals into directional voltage with varying current;
a diode or suitable device, which has plurality, for making the electrical current flow in one direction;
a relay or suitable electronic device, which has plurality, for stopping, or diverting the flow of electricity;
a hydrostatic pump or suitable device, which has plurality, for providing single directional pressure to the hydraulic brake line;
a pneumatic line connection, for supplying air pressure to secondary pneumatic lines;
a secondary pneumatic lines, for supplying air pressure to pneumatic bypass valve; and
a pneumatic bypass valve or suitable device, which has plurality, for cutting the main air flow from holding tank and replace with adjustable air pressure from secondary pneumatic lines.

11. A trailer brake steering system for facilitating directional control of said trailer by manipulation of of said brakes, comprising:
a transmitter, for sending controlling signals to receiver;
an electric powered receiver with varying current output, for receiving signals from transmitter, and turning signals into directional voltage with varying current;
a diode or suitable device, which has plurality, for making the electrical current flow in one direction;
a relay or suitable electronic device, which has plurality, for stopping, or diverting the flow of electricity;
a hydrostatic pump or suitable device, which has plurality, for providing single directional pressure to the hydraulic brake line;
a pneumatic line connection, for supplying air pressure to secondary pneumatic lines;
a secondary pneumatic lines, for supplying air pressure to pneumatic bypass valve; and
a pneumatic bypass valve or suitable device, which has plurality, for cutting the main air flow from holding tank and replace with adjustable air pressure from secondary pneumatic lines.
